(19) United States
(12) Patent Application Publication
(10) Pub. No.: US 2015/0055861 A1
(43) Pub. Date: Feb. 26, 2015

(54) Methods and Systems for Image Demosaicing

(71) Applicant: Amlogic Co., Ltd, Santa Clara, CA (US)

(72) Inventors: Dongjian Wang, San Jose, CA (US); Xuyun Chen, San Jose, CA (US)

(73) Assignee: Amlogic Co., Ltd, Santa Clara, CA (US)

(21) Appl. No.: 13/975,178

(22) Filed: Aug. 23, 2013

(51) Int. Cl. G06T 11/00; G06T 3/00

(52) U.S. Cl. CPC G06T 11/001; G06T 3/0093
USPC 382/167

(57) ABSTRACT

A method for demosaicing color filter array (“CFA”) pixels, comprises the steps of: receiving an array of the CFA pixels; demosaicing certain ones of the CFA pixels as a function of the relative vertical positions of the certain ones of the CFA pixels in the array, wherein the certain ones of the CFA pixels are along a first column of the array; and outputting, in parallel, the demosaiced certain ones of the CFA pixels for post-processing of the CFA pixels.

### FIELD OF INVENTION

This invention generally relates to methods and systems for image signal processing, and, in particular, to methods and systems for image demosaicing.

### BACKGROUND

Typically, to capture a color image using a single charge coupled device (“CCD”), the CCD records the image into an array of pixels to represent the color image. Each of the pixels has a digital pixel value (i.e., a number associated with the light intensity received by that respective pixel). A color filter array (“CFA”) is typically used for measuring only light intensity from a single color component on any particular pixel. In addition, a CMOS sensor is now more and more popular for capturing color images due to low production costs, low power consumption, and efficient production of CMOS sensor technology. CMOS sensor technology can also use a color filter array to produce a color component for each pixel position during an image capture.

The most common type of color filter array is a “Bayer color filter array,” which is described in U.S. Pat. No. 3,971,065. Bayer color filter arrays consist of alternating red and green filters in a first row and alternating green and blue filters in a second row. This pattern is repeated throughout the array. Thus, in an image employing a Bayer CFA, one-half of the pixels are sensitive to green light, one-quarter are sensitive to red light, and the remaining one-quarter are sensitive to blue light.

To display a full color image on a display (e.g., a television, mobile phone, computing tablet, LCD screen, etc.), however, red, green, and blue values are required for every pixel to be shown on the display. Thus, unknown color values for each pixel of the CFA must be estimated, usually by reference to other nearby known pixel values using interpolation. For example, if a pixel at a certain row and column is used for storing the intensity value of a red color component at that pixel, then blue and green color components at this pixel can be estimated through interpolation of blue and green color component values of nearby pixels. This estimation process is often referred to as “demosaicing.” After demosaicing is performed on the pixels of the CFA data, then the pixels can be referred to as “demosaiced pixels”. The demosaiced pixels can then be further processed and/or displayed on the display for viewing.

FIG. 1 illustrates a block diagram of the prior art for image processing, where line buffers are used to store and output the demosaiced pixels in parallel for post-processing. Generally, CFA data is received in line buffers 10 to be outputted to the demosaicing block 12. The demosaicing block 12 serially processes the pixels one-by-one for post-processing. After demosaicing, each of the processed pixels has a plurality of color information (e.g., RGB data or YUV data) for that particular pixel. The color information for the processed pixels (e.g., RGB data) is outputted from a single output of the demosaicing block 12 to line buffers 14 for storage. The line buffers 14 further outputs the stored color information in parallel to a post-processing block 16. Since the demosaiced pixels are stored along a plurality of line buffers for parallel output, chip memory is needed for implementing the line buffers 14 to store the demosaiced pixels. Unfortunately, using the line buffers 14 for parallel output of the demosaiced pixels to a post-processing block 16 is expensive and wastes valuable on-chip area.

Therefore, there exists a need for new methods and systems for demosaicing pixels and to output the demosaiced pixels to a post-processing block without needing line buffers between the demosaicing block and the post-processing block.

### SUMMARY OF INVENTION

An object of this invention is to provide methods and systems for image demosaicing, where demosaiced pixel data are processed and outputted in parallel for post processing.

Another object of this invention is to provide methods and systems for image demosaicing, where line buffers are not necessary for outputting the demosaiced pixel data to a post-processing block.

Yet another object of this invention is to provide methods and systems for image demosaicing that can operate at lower power than the current art for image demosaicing.

Briefly, the present invention discloses a method for demosaicing color filter array (“CFA”) pixels, comprising the steps of: receiving an array of the CFA pixels; demosaicing certain ones of the CFA pixels as a function of the relative vertical positions of the certain ones of the CFA pixels in the array, wherein the certain ones of the CFA pixels are along a first column of the array; and outputting, in parallel, the demosaiced certain ones of the CFA pixels for post-processing of the CFA pixels.

An advantage of this invention is that methods and systems for image demosaicing are provided, where demosaiced pixel data are processed and outputted in parallel for post processing.

Another advantage of this invention is that methods and systems for image demosaicing are provided, where line buffers are not necessary for outputting the demosaiced pixel data to a post-processing block.

Yet another advantage of this invention is that methods and systems for image demosaicing that can operate at lower power than the current art for image demosaicing are provided.

### DESCRIPTION OF THE DRAWINGS

The foregoing and other objects, aspects, and advantages of the invention can be better understood from the following detailed description of the preferred embodiment of the invention when taken in conjunction with the accompanying drawings in which:

FIG. 1 illustrates a block diagram of the prior art for image processing, where line buffers are used to store and output the demosaiced pixels in parallel.

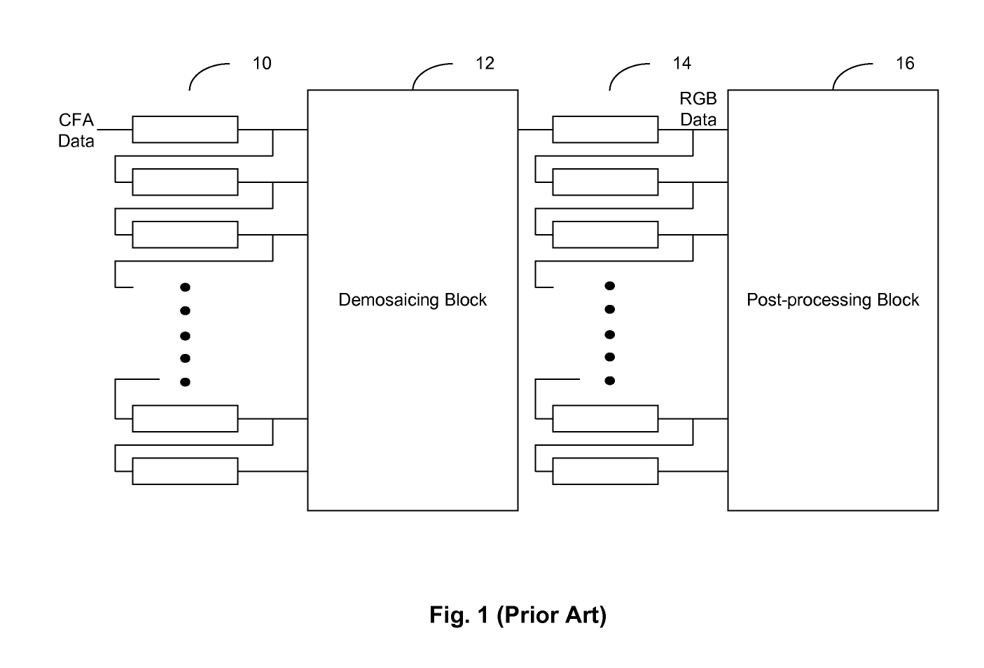

FIG. 2 illustrates a block diagram of the present invention for image processing, where a demosaicing block processes data for parallel output.

FIG. 3 illustrates an example of a processing window of CFA data.

FIG. 4 illustrates a method of the present invention from demosaicing a processing window of CFA data for parallel output.

### DETAILED DESCRIPTION OF THE PREFERRED EMBODIMENTS

In the following detailed description of the embodiments, reference is made to the accompanying drawings, which form a part hereof, and in which is shown by way of illustration of specific embodiments in which the present invention may be practiced. To aid in the understanding of the invention, the RGB standard is used in the following examples. However, it is understood that other image and video standards can be used in relation to the present invention since most of these image and video standards have CFA data that need to be demosaiced for display of the original image.

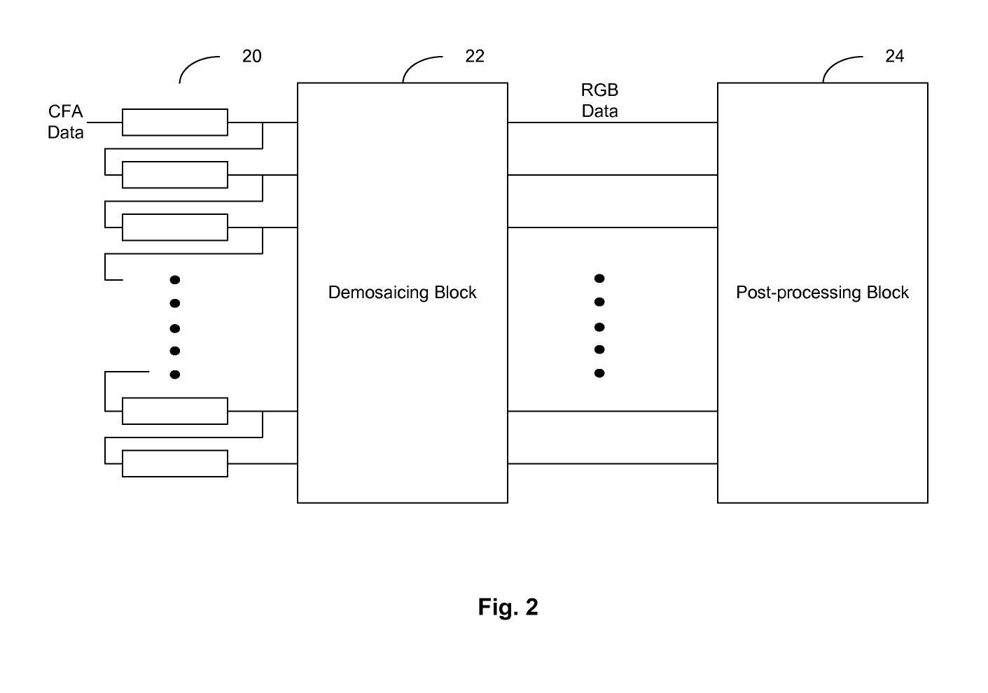

FIG. 2 illustrates a block diagram of the present invention for image processing, where a demosaicing block processes data for parallel output. CFA data can be inputted to line buffers 20 for storage, and then outputted in parallel to the demosaicing block 22. The CFA data that is outputted to the demosaicing block 22 form a processing window for demosaicing. The processing window comprises an array of CFA pixels, where each CFA pixel has one type of color information, e.g., in the RGB standard, the CFA pixel can either be a red, green, or blue color component. In order for the image to be displayed using the CFA data, the CFA data needs to be demosaiced such that each pixel can have several types of color information, e.g., in the RGB standard, each pixel may have red color information, blue color information, and green color information. A CFA pixel can be demosaiced by interpolating missing color components for that CFA pixel based upon the processing window.

The demosaicing block 22 can implement various methods for interpolating the other color components for the CFA pixels of the processing window. Once demosaiced, the demosaiced pixel may have up to three color components. The demosaiced pixels are outputted in parallel to the post-processing block 24 for further processing. The post-processing block 24 can perform one or more various operations to improve image quality, e.g., noise reduction, peaking and sharpness control, etc.

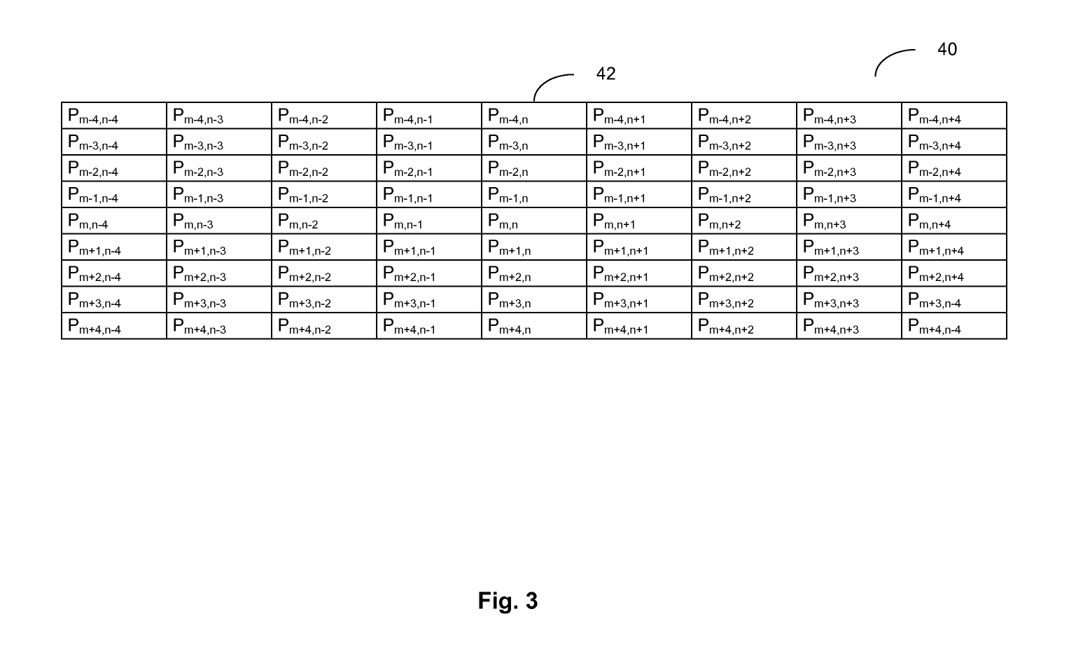

FIG. 3 illustrates an example of a processing window of CFA data. A processing window 40 can be inputted to the demosaicing block 22. A processing window can be an array of CFA pixels of varying pixel height and pixel width. Typically, the pixel height and pixel width can be dependent one or more of the following: (1) the computational power of the respective image processing system for interpolating multiple pixels; (2) upon system requirements of the respective image processing system; (3) the number of parallel output lines to the post-processing block; (4) the type of demosaicing algorithm used; and (5) other performance considerations.

The demosaicing block 22 can interpolate the various color information for several of the CFA pixels of the processing window in parallel. Since each of the CFA pixels can only have data for a certain single color component, other luminosity data for any other color components for that pixel must be interpolated. Typically, interpolation for a color component of a current pixel can be based on the color components of other neighboring pixels in the processing window. For instance, the pixels P_{m-2,n} to P_{m+2,n} of column 42 can be interpolated for parallel output by the demosaicing block 22. The accuracy of the interpolation can be dependent on the number of CFA pixels used to interpolate the certain pixel.

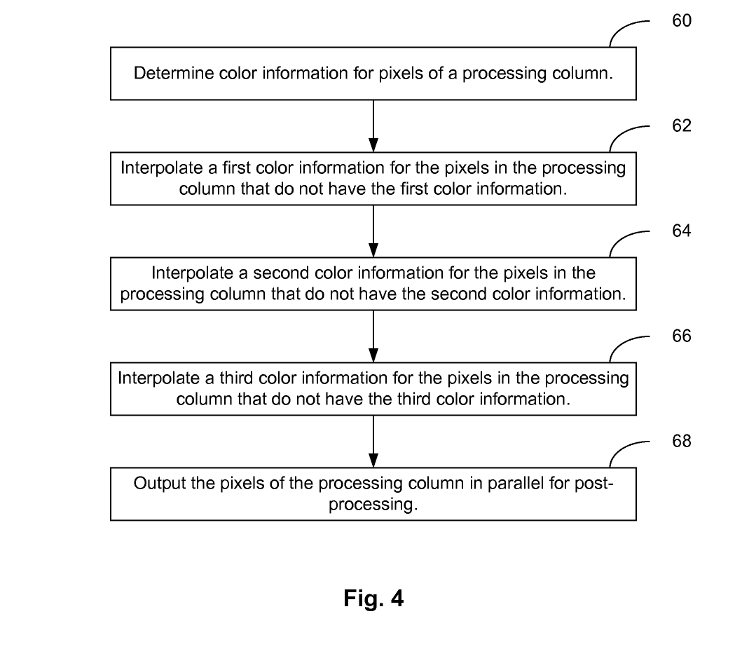

FIG. 4 illustrates a method of the present invention for demosaicing CFA data for parallel output. In order to interpolate a column of pixels in a processing window for the CFA data, the color information for the pixels in the column must be determined 60. In the RGB standard, a column can either be alternating green and red CFA pixels, or alternating green and blue CFA pixels. Once the single color component of the CFA pixels is known, a first color component for the pixels in the column that do not have this color information is interpolated from other CFA pixels in the processing window 62. Next, a second color component for the pixels in the column that do not have this color information is interpolated from other CFA pixels in the processing window 64. Finally, a third color component for the pixels in the column that do not have this color information is interpolated from other CFA pixels in the processing window 66. Once the pixels in the column have all three color components, the demosaicing process is completed and these demosaiced pixels are outputted in parallel for post-processing.

Next, the next column of pixels in the processing window can be demosaiced for parallel output to the post-processor until the CFA image is demosaiced. Furthermore, the color components that were interpolated for the previous demosaiced pixels can be saved and used for demosaicing the next column(s) of pixels in the processing window.

Interpolation for an Unknown Color Component(S) of a Pixel

Generally, in the demosaicing step, interpolation can be performed concurrently on multiple pixels since each pixel to be interpolated may use different color components of neighboring pixels for interpolation. Furthermore, multiple interpolation methods can also be used concurrently since some of the multiple pixels may not have the same neighboring pixel information as the other ones of the multiple pixels to be interpolated.

For instance, referring to FIG. 3, if pixels P_{m-2,n} to P_{m+2,n} of the column 42 are to be interpolated, then each of the pixels P_{m-2,n} to pixel P_{m+2,n} may be interpolated differently since each has a different number of neighboring vertical pixels in the window 40. Here, pixel P_{m-2,n} does not have the same number of neighboring vertical pixels available for interpolation than the pixel P_{m,n}. The pixel P_{m,n} can have up to nine lines of the pixels P_{m-4,n} to P_{m+4,n} to use for interpolation. Whereas for the pixels near or at the borders of the window 40 (can also be referred to as “boarding pixels”), e.g., the pixel P_{m-2,n}, those pixels may have fewer lines in the window to use for interpolation. In an example, if the pixel P_{m-4,n} was to be interpolated for missing color components, then the demosaicing step cannot use any lines above the pixel P_{m-4,n} since that information is not known in the window. Therefore, each of the pixels along the same column, e.g., the pixels, P_{m-2,n} to P_{m+2,n}, may be interpolated using a different number of vertical pixels and/or using different interpolation methods altogether.

With respect to horizontal interpolation of color components for the pixels P_{m-2,n} to P_{m+2,n} in the window 42, the same number of horizontally neighboring pixels can be used for each of the pixels P_{m-2,n} to P_{m+2,n} since the relative horizontal position, i.e., column n, of the pixels P_{m-2,n} to P_{m+2,n} in the window 40 are the same.

One or more of the following interpolation methods can be used to process pixels of a processing window: neighboring pixel interpolation; mirrored pixel interpolation; intra-column pixel interpolation; inter-row pixel interpolation; sequential demosaicing methods; iterative demosaicing methods; and other interpolation methods. The method employed can depend on the relative vertical position of the pixels in a column to be processed within the processing window.

Neighboring Pixel Interpolation

A method for interpolating a specific pixel is to interpolate a missing color component for a current pixel based on averaging color components of that color from neighboring pixels surrounding the current pixel. For instance, in reference to FIG. 3, if a blue color component for the current pixel P_{m,n} is to be interpolated based upon the neighboring pixels P_{m-1,n}, P_{m,n+1}, Pₘ₊₁, and P_{m,n-1}, then the average blue color component from the neighboring pixels can be assigned as the missing blue color component for the pixel P_{m,n}. The averaging of the neighboring pixels can be weighted. Also, averaging can take into account other neighboring pixels that maybe two or more columns or rows away from the current pixel. The averaging function can be dependent on the accuracy needed, the amount of computational power of the respective system, and other system considerations or requirements. In this manner, any other missing color components for a current pixel can be interpolated based on its neighboring pixels.

Mirrored Pixel Interpolation

However, certain pixels of the processing window may not have some neighboring pixels to interpolate a missing color component. For instance, the pixel P_{m-4,n} has a left, right, and bottom neighboring pixel, but does not have a top pixel in the processing window. Thus, the subsequent rows in the processing window 40 from the current pixel, e.g., row m-3 and downwards, can be mirrored as rows for the top of the current pixel pixel P_{m-4,n} for the purpose of interpolation. Thereby, interpolation can be conducted reusing pixels from the processing window as substitutes for non-existent pixels in the processing window 40.

Thus in an embodiment of the present invention, for a column of a processing window to be demosaiced, the bordering pixel of the column can use a mirrored pixel interpolation and the inner pixels of the column can used a different interpolation method, for instance, neighboring interpolation.

Intra-Column Pixel Interpolation

In another method for interpolating a specific pixel is to interpolate a missing color component for a current pixel based on averaging color components of that color from pixels along the same column as the current pixel. For instance, in reference to FIG. 3, if a blue color component for the current pixel P_{m,n} is to be interpolated based upon the pixels P_{m-4,n} through P_{m+4,n} along column n, the average blue color component from these pixels in column n can be assigned as the missing blue color component for the pixel P_{m,n}. Also, the averaging of the pixels in column n can be weighted and take into account neighboring pixels as well. Furthermore, the number of pixels in the same column to use for interpolation can vary depending on the amount of accuracy needed, the color components of the pixels, the size of the processing window, and other factors. In this manner, any other missing color components for a current pixel can be interpolated based on pixels in the same column.

Inter-Row Pixel Interpolation

In another method for interpolating a specific pixel is to interpolate a missing color component for a current pixel based on averaging color components of that color from pixels along the same row as the current pixel. For instance, in reference to FIG. 3, if a blue color component for the current pixel P_{m,n} is to be interpolated based upon the pixels P_{m,n-4} through P_{m,n+4} along row m, the average blue color component from these pixels in row m can be assigned as the missing blue color component for the pixel P_{m,n}. Also, the averaging of the pixels in row m can be weighted and take into account neighboring pixels as well. Furthermore, the number of pixels in the same row to use for interpolation can vary depending on the amount of accuracy needed, the color components of the pixels, the size of the processing window, and other factors. In this manner, any other missing color components for a current pixel can be interpolated based on pixels in the same row as the current pixel.

Other Interpolation Methods

Other interpolation methods can be employed since the processing window can provide various color component information for multiple pixels. Furthermore, since several pixels can be concurrently interpolated, several interpolation methods can be employed concurrently for the pixels as well, such that one of the pixels may be best interpolated using a first type of interpolation method and a second one of the pixels may be best interpolated using a second type of interpolation method.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred apparatuses, methods, and systems described herein, but all those other and further alterations and modifications as would be apparent to those of ordinary skilled in the art.

We Claim:

1. A method for demosaicing color filter array (“CFA”) pixels, comprising the steps of:
receiving an array of the CFA pixels;
demosaicing certain ones of the CFA pixels as a function of the relative vertical positions of the certain ones of the CFA pixels in the array, wherein the certain ones of the CFA pixels are along a first column of the array; and
outputting, in parallel, the demosaiced certain ones of the CFA pixels for post-processing of the CFA pixels.

2. The method of claim 1 in the demosaicing step, wherein missing color components of the certain ones of the CFA pixels are interpolated, and wherein the interpolated color components are stored for use during demosaicing of other ones of the CFA pixels of the received array.

3. The method of claim 2 wherein the other ones of the CFA pixels are along a second column of the array.

4. The method of claim 1, wherein in the demosaicing step, the certain ones of the CFA pixels comprise one or more bordering pixels and wherein the bordering pixels are demosaiced using a mirrored interpolation method.

5. The method of claim 1, wherein in the demosaicing step, the certain ones of the CFA pixels comprise one or more inner pixels and wherein the inner pixels are demosaiced using a neighboring pixel interpolation method.

6. A method for demosaicing color filter array (“CFA”) pixels, comprising the steps of:
receiving an array of the CFA pixels;
demosaicing certain ones of the CFA pixels as a function of the relative vertical positions of the certain ones of the CFA pixels in the array, wherein the certain ones of the CFA pixels are along a first column of the array, wherein missing color components of the certain ones of the CFA pixels are interpolated, and wherein the interpolated color components are stored for use during demosaicing of other ones of the CFA pixels of the received array; and
outputting, in parallel, the demosaiced certain ones of the CFA pixels for post-processing of the CFA pixels,
wherein the demosaiced certain ones are displayed on a display.

7. The method of claim 6 wherein the other ones of the CFA pixels are along a second column of the array.

8. The method of claim 6, wherein in the demosaicing step, the certain ones of the CFA pixels comprise one or more bordering pixels and wherein the bordering pixels are demosaiced using a mirrored interpolation method.

9. The method of claim 6, wherein in the demosaicing step, the certain ones of the CFA pixels comprise one or more inner pixels and wherein the inner pixels are demosaiced using a neighboring pixel interpolation method.

10. A method for demosaicing color filter array (“CFA”) pixels, comprising the steps of:
receiving an array of the CFA pixels;
demosaicing certain ones of the CFA pixels as a function of the relative vertical positions of the certain ones of the CFA pixels in the array, wherein the certain ones of the CFA pixels are along a first column of the array, wherein missing color components of the certain ones of the CFA pixels are interpolated, wherein the interpolated color components are stored for use during demosaicing of other ones of the CFA pixels of the received array, and wherein the other ones of the CFA pixels are along a second column of the array; and
outputting, in parallel, the demosaiced certain ones of the CFA pixels for post-processing of the CFA pixels,
wherein the demosaiced certain ones are displayed on a display.

11. The method of claim 10, wherein in the demosaicing step, the certain ones of the CFA pixels comprise one or more bordering pixels and wherein the bordering pixels are demosaiced using a mirrored interpolation method.

12. The method of claim 10, wherein in the demosaicing step, the certain ones of the CFA pixels comprise one or more inner pixels and wherein the inner pixels are demosaiced using a neighboring pixel interpolation method.
